(19) United States
(12) Patent Application Publication
(10) Pub. No.: US 2022/0102756 A1
(43) Pub. Date: Mar. 31, 2022

(54) METHODS FOR FORMING SOLID GEL ELECTROLYTE MEMBRANES AND BATTERIES INCORPORATING THE SAME

(71) Applicant: GM GLOBAL TECHNOLOGY OPERATIONS LLC, DETROIT, MI (US)

(72) Inventors: Bradley R. Frieberg, Farmington Hills, MI (US); Xiaosong Huang, Novi (US)

(21) Appl. No.: 17/038,761

(22) Filed: Sep. 30, 2020

(51) Int. Cl. H01M 10/0565; H01M 4/133; H01M 4/38; H01M 4/58

(52) U.S. Cl. CPC H01M 10/0565; H01M 4/133; H01M 2300/0065; H01M 4/58; H01M 4/386

(57) ABSTRACT

Methods for forming battery cells include providing a porous polymeric membrane (PPM), imbibing the PPM with a plasticizing solution comprising plasticizers and lithium salts to form a solid gel electrolyte film, and disposing the solid gel electrolyte film between an anode and a cathode. The PPM can be provided as a coating on the anode or the cathode. The plasticizers can be triethylene glycol dimethyl ether (triglyme), tetraethylene glycol dimethyl ether, and triethyl phosphate. The salts can be LiBF₄, LiClO₄, LiPF₆, LiAsF₆, LiTf, LiFSI, LiTFSI, and LIBOB. The plasticizer solution can be 17.5 wt. % to 27.5 wt. % LiTFSI and 72.5 wt. % to 82.5 wt. % triglyme. The plasticizer solution can be 56 wt. % to 66 wt. % LiTFSI and 33.5 wt. % to 43.5 wt. % triglyme. The plasticizer solution can be 16 wt. % to 26 wt. % LiTFSI, 9 wt. % to 19 wt. % triglyme, and 55 wt. % to 75 wt. % triethyl phosphate.

### INTRODUCTION

Lithium ion batteries describe a class of rechargeable batteries in which lithium ions move between a negative electrode (i.e., anode) and a positive electrode (i.e., cathode). Liquid, solid, and polymer electrolytes can facilitate the movement of lithium ions between the anode and cathode. Lithium ion batteries further include a porous separator disposed between the anode and the cathode capable of facilitating the movement of lithium ions throughout the electrode. Such separators commonly include a polymeric body with an inert ceramic coating. Lithium ion batteries are growing in popularity for defense, automotive, and aerospace applications due to their high energy density and ability to undergo successive charge and discharge cycles.

### SUMMARY

Provided are methods for forming a battery cell including providing a porous polymeric membrane, imbibing the porous polymeric membrane with a plasticizing solution including one or more plasticizers and one or more lithium salts to form a solid gel electrolyte film, and disposing the solid gel electrolyte film between an anode and a cathode. The porous polymeric membrane can be provided as a coating on the anode. The porous polymeric membrane can be provided as a coating the cathode. The porous polymeric membrane can include polyvinylidene fluoride-co-hexafluoropropylene. The porous polymeric membrane can have a porosity of 20 vol. % to 90 vol. %. The porous polymeric membrane can further include filler particles selected from the list consisting of metal oxides and solid electrolyte powders. The filler particles can have an average particle size of 10 nm to 3 μm. The porous polymeric membrane can include 10 wt. % to 60 wt. % filler particles. The one or more plasticizers can be triethylene glycol dimethyl ether, tetraethylene glycol dimethyl ether, triethyl phosphate, and combinations thereof. The one or more lithium salts can be LiBF₄, LiClO₄, LiPF₆, LiAsF₆, LiTf, LiFSI, LiTFSI, LIBOB, and combinations thereof. The plasticizer solution can be 17.5 wt. % to 27.5 wt. % LiTFSI and 72.5 wt. % to 82.5 wt. % triethylene glycol dimethyl ether. The plasticizer solution can be 56 wt. % to 66 wt. % LiTFSI and 33.5 wt. % to 43.5 wt. % triethylene glycol dimethyl ether. The plasticizer solution can be 16 wt. % to 26 wt. % LiTFSI, 9 wt. % to 19 wt. % triethylene glycol dimethyl ether, and 55 wt. % to 75 wt. % triethyl phosphate. The solid gel electrolyte film can have a thickness of 20 μm to 100 μm. The porous polymeric membrane can be a solid body populated with a plurality of pores, and imbibing includes impregnating the plurality of pores and the solid body with the one or more lithium salts. The anode can include LTO, graphite, or silicon particles and/or SiOₓ particles, and the cathode can include LMO, lithium iron phosphate, lithium manganese iron phosphate, NMC, NCMA, or HE-NMC.

Provided are methods for forming a solid gel electrolyte membrane for a battery cell including providing a porous polymeric membrane made from polyvinylidene fluoride-co-hexafluoropropylene, and imbibing the porous polymeric membrane with a plasticizing solution to form a solid gel electrolyte film. The plasticizing solution includes LiTFSI and one or more plasticizers selected from the list consisting of triethylene glycol dimethyl ether, tetraethylene glycol dimethyl ether, and Triethyl Phosphate. The plasticizer solution can be 17.5 wt. % to 27.5 wt. % LiTFSI and 72.5 wt. % to 82.5 wt. % triethylene glycol dimethyl ether. The plasticizer solution can be 56 wt. % to 66 wt. % LiTFSI and 33.5 wt. % to 43.5 wt. % triethylene glycol dimethyl ether. The plasticizer solution can be 16 wt. % to 26 wt. % LiTFSI, 9 wt. % to 19 wt. % triethylene glycol dimethyl ether, and 55 wt. % to 75 wt. % triethyl phosphate.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 illustrates a lithium battery cell, according to one or more embodiments; and

FIG. 2 illustrates a schematic diagram of a hybrid-electric vehicle, according to one or more embodiments.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Provided herein are solid gel electrolyte membranes suitable for use as battery separators which are flexible and highly impregnated with lithium ions. Advantageously, the solid gel electrolyte membranes provided herein obviate the need for liquid electrolytes and further enhance the mechanical integrity of battery cells into which they are incorporated.

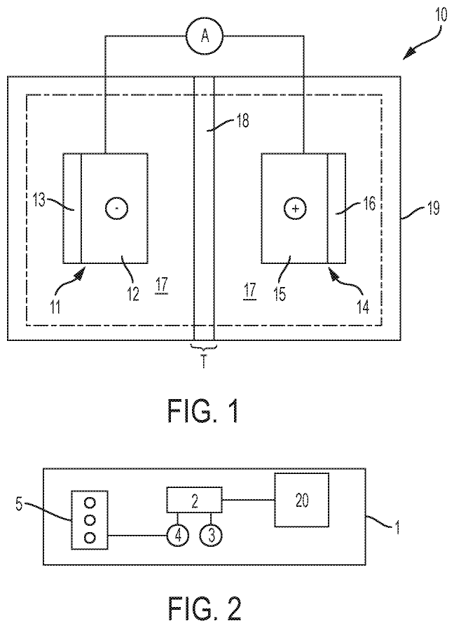

FIG. 1 illustrates a lithium battery cell 10 comprising a negative electrode (i.e., the anode) 11, a positive electrode (i.e., the cathode) 14, an electrolyte 17 operatively disposed between the Anode 11 and the cathode 14, and a separator 18. Anode 11, cathode 14, and electrolyte 17 can be encapsulated in container 19, which can be a hard (e.g., metallic) case or soft (e.g., polymer) pouch, for example. The Anode 11 and cathode 14 are situated on opposite sides of separator 18 which comprises a solid gel electrolyte membrane as described below. In general, the separator 18 is a microporous polymer or other suitable material capable of conducting lithium ions and optionally electrolyte (i.e., liquid electrolyte). Electrolyte 17 is can be a liquid electrolyte comprising one or more lithium salts dissolved in a non-aqueous solvent, or a solid electrolyte or gel electrolyte as are known in the art. Anode 11 generally includes a current collector 12 and a lithium intercalation host material 13 applied thereto. Cathode 14 generally includes a current collector 15 and a lithium-based active material 16 applied thereto. For example, the battery cell 10 can comprise a lithium metal oxide active material 16, among many others, as will be described below. Active material 16 can store lithium ions at a higher electric potential than intercalation host material 13, for example. The current collectors 12 and 15 associated with the two electrodes are connected by an interruptible external circuit that allows an electric current to pass between the electrodes to electrically balance the related migration of lithium ions. Although FIG. 1 illustrates host material 13 and active material 16 schematically for the sake of clarity, host material 13 and active material 16 can comprise an exclusive interface between the anode 11 and cathode 14, respectively, and electrolyte 17.

Battery cell 10 can be used in any number of applications. For example, FIG. 2 illustrates a schematic diagram of a hybrid-electric vehicle 1 including a battery pack 20 and related components. A battery pack such as the battery pack 20 can include a plurality of battery cells 10. A plurality of battery cells 10 can be connected in parallel to form a group, and a plurality of groups can be connected in series, for example. One of skill in the art will understand that any number of battery cell connection configurations are practicable utilizing the battery cell architectures herein disclosed, and will further recognize that vehicular applications are not limited to the vehicle architecture as described. Battery pack 20 can provide energy to a traction inverter 2 which converts the direct current (DC) battery voltage to a three-phase alternating current (AC) signal which is used by a drive motor 3 to propel the vehicle 1. An engine 5 can be used to drive a generator 4, which in turn can provide energy to recharge the battery pack 20 via the inverter 2. External (e.g., grid) power can also be used to recharge the battery pack 20 via additional circuitry (not shown). Engine 5 can comprise a gasoline or diesel engine, for example.

Battery cell 10 generally operates by reversibly passing lithium ions between Anode 11 and cathode 14. Lithium ions move from cathode 14 to Anode 11 while charging, and move from Anode 11 to cathode 14 while discharging. At the beginning of a discharge, Anode 11 contains a high concentration of intercalated/alloyed lithium ions while cathode 14 is relatively depleted, and establishing a closed external circuit between Anode 11 and cathode 14 under such circumstances causes intercalated/alloyed lithium ions to be extracted from Anode 11. The extracted lithium atoms are split into lithium ions and electrons as they leave an intercalation/alloying host at an electrode-electrolyte interface. The lithium ions are carried through the micropores, lithium salts, and/or filter particles (described below) of separator 18 from Anode 11 to cathode 14 by the ionically conductive electrolyte 17 while, at the same time, the electrons are transmitted through the external circuit from Anode 11 to cathode 14 to balance the overall electrochemical cell. This flow of electrons through the external circuit can be harnessed and fed to a load device until the level of intercalated/alloyed lithium in the negative electrode falls below a workable level or the need for power ceases.

Battery cell 10 may be recharged after a partial or full discharge of its available capacity. To charge or re-power the lithium ion battery cell, an external power source (not shown) is connected to the positive and the negative electrodes to drive the reverse of battery discharge electrochemical reactions. That is, during charging, the external power source extracts the lithium ions present in cathode 14 to produce lithium ions and electrons. The lithium ions are carried back through the separator by the electrolyte 17, and the electrons are driven back through the external circuit, both towards Anode 11. The lithium ions and electrons are ultimately reunited at the negative electrode, thus replenishing it with intercalated/alloyed lithium for future battery cell discharge.

Lithium ion battery cell 10, or a battery module or pack comprising a plurality of battery cells 10 connected in series and/or in parallel, can be utilized to reversibly supply power and energy to an associated load device. Lithium ion batteries may also be used in various consumer electronic devices (e.g., laptop computers, cameras, and cellular/smart phones), military electronics (e.g., radios, mine detectors, and thermal weapons), aircrafts, and satellites, among others. Lithium ion batteries, modules, and packs may be incorporated in a vehicle such as a hybrid electric vehicle (HEV), a battery electric vehicle (BEV), a plug-in HEV, or an extended-range electric vehicle (EREV) to generate enough power and energy to operate one or more systems of the vehicle. For instance, the battery cells, modules, and packs may be used in combination with a gasoline or diesel internal combustion engine to propel the vehicle (such as in hybrid electric vehicles), or may be used alone to propel the vehicle (such as in battery powered vehicles).

Returning to FIG. 1, electrolyte 17 conducts lithium ions between anode 11 and cathode 14, for example during charging or discharging the battery cell 10. The electrolyte 17 comprises one or more solvents, and one or more lithium salts dissolved in the one or more solvents. Suitable solvents can include cyclic carbonates (ethylene carbonate, propylene carbonate, butylene carbonate), acyclic carbonates (dimethyl carbonate, diethyl carbonate, ethylmethylcarbonate), aliphatic carboxylic esters (methyl formate, methyl acetate, methyl propionate), γ-lactones (γ-butyrolactone, γ-valerolactone), chain structure ethers (1,3-dimethoxypropane, 1,2-dimethoxyethane (DME), 1-2-diethoxyethane, ethoxymethoxyethane), cyclic ethers (tetrahydrofuran, 2-methyltetrahydrofuran, 1,3-dioxolane), and combinations thereof. A non-limiting list of lithium salts that can be dissolved in the organic solvent(s) to form the non-aqueous liquid electrolyte solution include LiClO₄, LiAlCl₄, LiI, LiBr, LiSCN, LiBF₄, LiB(C₆H₅)₄ LiAsF₆, LiCF₃SO₃, LiN(CF₃SO₂)₂, LiN(FSO₂)₂, LiPF₆, and mixtures thereof.

A liquid electrolyte 17 can be a gel electrolyte, in some embodiments. Gel electrolytes 17 allows lithium ions to travel through the gel electrolyte 17 without the gel electrolyte 17 flowing in and out of one or more of the active material 16 and the host material 13. Generally, gel electrolytes have a high viscosity (e.g., >10⁶ mPa S) which is high enough to prevent the gel electrolyte from flowing in and out of one or more of the active material 16 and the host material 13 yet low enough such that transport of lithium ions through the gel electrolyte 17 is not inhibited. In a particular example, a gel electrolyte can include one or more fluorinated monomers, one or more lithium salts, and one or more solvents, among others known in the art. Active material 16 can include any lithium-based active material that can sufficiently undergo lithium intercalation and deintercalation while functioning as the positive terminal of battery cell 10. Active material 16 can also include a polymer binder material to structurally hold the lithium-based active material together. The active material 16 can comprise lithium transition metal oxides described below. Cathode current collector 15 can include aluminum or any other appropriate electrically conductive material known to skilled artisans, and can be formed in a foil or grid shape. Cathode current collector 15 can be treated (e.g., coated) with highly electrically conductive materials, including one or more of conductive carbon black, graphite, carbon nanotubes, carbon nanofiber, graphene, and vapor growth carbon fiber (VGCF), among others. The same highly electrically conductive materials can additionally or alternatively be dispersed within the host material 13.

Lithium transition metal oxides suitable for use as active material 16 can comprise one or more of spinel lithium manganese oxide (LiMn₂O₄), lithium cobalt oxide (LiCoO₂), a nickel-manganese oxide spinel (Li(Ni_{0.5}Mn_{1.5})O₂), a layered nickel-manganese-cobalt oxide (having a general formula of xLi₂MnO₃.(1−x)LiMO₂, where M is composed of any ratio of Ni, Mn and/or Co). A specific example of the layered nickel-manganese oxide spinel is xLi₂MnO₃.(1−x)Li(Ni_{1/3}Mn_{1/3}Co_{1/3})O₂. Other suitable lithium-based active materials include Li(Ni_{1/3}Mn_{1/3}Co_{1/3})O₂), LiNiO₂, Li_{x+y}Mn_{2-y}O₄ (LMO, 0<x<1 and 0<y<0.1), or a lithium iron polyanion oxide, such as lithium iron phosphate (LiFePO₄,), lithium manganese iron phosphate (LiMn₁₋ₓFeₓPO₄) or lithium iron fluorophosphate (Li₂FePO₄F). Other lithium-based active materials may also be utilized, such as LiNiₓM₁₋ₓO₂(M is composed of any ratio of Al, Co, and/or Mg), LiNi₁₋ₓCo_{1-y}Mn_{x+y}O₂ or LiMn_{1.5-x}Ni_{0.5-y}M_{x+y}O₄ (M is composed of any ratio of Al, Ti, Cr, and/or Mg), stabilized lithium manganese oxide spinel (LiₓMn_{2-y}M_{y}O₄, where M is composed of any ratio of Al, Ti, Cr, and/or Mg), lithium nickel cobalt aluminum oxide (e.g., LiNi_{0.8}Co_{0.15}Al_{0.05}O₂ or NCA), aluminum stabilized lithium manganese oxide spinel (LiₓMn₂₋ₓAl_{y}O₄), lithium vanadium oxide (LiV₂O₅), Li₂MSiO₄ (M is composed of any ratio of Co, Fe, and/or Mn), and any other high efficiency nickel-manganese-cobalt material. By “any ratio” it is meant that any element may be present in any amount. So, for example, M could be Al, with or without Co and/or Mg, or any other combination of the listed elements. In another example, anion substitutions may be made in the lattice of any example of the lithium transition metal based active material to stabilize the crystal structure. For example, any 0 atom may be substituted with an F atom.

In particular, suitable active materials 16 include lithium iron phosphate, lithium manganese iron phosphate, NMC, NCMA, and HE-NMC materials. NMC active materials 16 can include materials defined by the formula LiNiₓCo_{y}Mn_{z}O₂, wherein 0.33<x<0.85, 0.05<y<0.33, 0.05<z<0.33, and x+y+z=1 (e.g., LiNi_{0.8}Co_{0.1}Mn_{0.1}O₂ (NMC811), LiNi_{0.6}Mn_{0.2}Co_{0.2}O₂ (NMC622)). NCMA active materials 16 can include materials defined by the formula LiNiₐCo_{b}Mn_{c}Al_{d}O₂, wherein 0.33<a<0.9, 0.05<b<0.33, 0.05<c<0.33, 0.01<d<0.02, and a+b+c+d=1 (e.g., Li[Ni_{0.89}Co_{0.05}Mn_{0.05}Al_{0.01}]O₂). RE-NMC active materials 16 can include Li_{1.2}Mn_{0.525}Ni_{0.175}Co_{0.1}O₂, among other high-energy NMC materials.

The anode current collector 12 can include copper, aluminum, stainless steel, or any other appropriate electrically conductive material known to skilled artisans. Anode current collector 12 can be treated (e.g., coated) with highly electrically conductive materials, including one or more of conductive carbon black, graphite, carbon nanotubes, carbon nanofiber, graphene, and vapor growth carbon fiber (VGCF), among others. The host material 13 applied to the anode current collector 12 can include any lithium host material that can sufficiently undergo lithium ion intercalation, deintercalation, and alloying, while functioning as the negative terminal of the lithium ion battery 10. Host material 13 can optionally further include a polymer binder material to structurally hold the lithium host material together. For example, in one embodiment, host material 13 can include a carbonaceous material (e.g., graphite) and/or one or more of binders (e.g., polyvinyldiene fluoride (PVdF), an ethylene propylene diene monomer (EPDM) rubber, carboxymethoxyl cellulose (CMC), and styrene, 1,3-butadiene polymer (SBR)), among others known in the art. In a particular embodiment, the host material 13 can comprise lithium titanate (e.g., Li₄₊ₓTi₅O₁₂, wherein 0<x<3, such as Li₄Ti₅O₁₂) (LTO). In a particular embodiment the host material 13 can comprise silicon particles and/or SiOₓ particles. SiOₓ particles, wherein generally x≤2, can vary in composition. In some embodiments, for some SiOₓ particles, x≈1. For example, x can be about 0.9 to about 1.1, or about 0.99 to about 1.01. Within a body of SiOₓ particles, SiO₂ and/or Si domains may further exist. Silicon host material 13 comprising Si particles or SiOₓ particles can comprise average particle diameters of about 20 nm to about 20 μm, among other possible sizes.

Methods for forming solid gel electrolyte films suitable for use as battery separators 18 and battery cells 10 incorporating the same can include providing a porous polymeric membrane, imbibing the porous polymeric membrane with a plasticizing solution comprising one or more plasticizers and one or more lithium salts to form a solid gel electrolyte film; and disposing the solid gel electrolyte film (i.e., separator 18) between an anode 11 and a cathode 14. The porous polymeric membrane comprises a solid body generally populated with a plurality of pores and can have a porosity of about 20 vol. % to 90 vol. %, 60 vol. % to 85 vol. %, or about 80 vol. %. The porous polymeric membrane can be made from various polymers, such as polyvinylidene fluoride (PVDF), polyvinylidene fluoride-co-hexafluoropropylene (PVDF-HFP), polymethyl methacrylate (PMMA), polyethylene oxide (PEO), polypropylene oxide (PPO), polystyrene-co-polyethylene oxide (PS-PEO), polystyrene sulfonate (PSS), polyacrylonitrile (PAN), polyvinyl chloride (PVC), polycarbonate (PC), polypropylene carbonate (PPC), polytrimethylene carbonate (PTMC), polyethylene carbonate (PEC), polyacrylic acid (PAA), polyimide (PI), polyamide (PA), polyvinyl acetate (PVAc) and combinations, blends and copolymers thereof. In a specific embodiment the porous polymeric membrane comprises PVDF-HFP.

The porous polymeric membrane can optionally further include filler particles such as metal oxides and solid electrolyte powders which improve the structure and ionic conductivity of the solid gel electrolyte films provided herein. In some embodiments porous polymeric membrane comprises filler particles selected from the list consisting of metal oxides and solid electrolyte powders. Examples of such filler particles include SiO₂, Al₂O₃, TiO₂, MgO, ZnO, LATP, and LLZO, among others. The filler particles can have an average particle size of about 10 nm to about 3 μm, or about 1 μm in some embodiments. The porous polymeric membrane can comprise about 10 wt. % to about 60 wt. % filler particles, for example.

The porous polymeric membrane can be provided as a stand-alone component or provided as a coating on an anode 11 or a coating on a cathode 14. In some embodiments, when the porous polymeric membrane is manufactured using certain water-based techniques (e.g., vapor induced phase inversion, non-solvent induced phase separation, or thermally induced phase separation), it can be desirable to provide the porous polymeric membrane as a coating on the anode 11, particularly when the appurtenant cathode 14 comprises a water-sensitive composition.

Imbibing the porous polymeric membrane with a plasticizing solution can include spraying the porous polymeric membrane with a plasticizing solution or dipping the porous polymeric membrane in a plasticizing solution, for example, among other suitable alternatives. Imbibing includes impregnating the pores and/or polymeric body of the membrane with the one or more lithium salts. The plasticizing solution can comprise one or more plasticizers, including triethylene glycol dimethyl ether (triglyme), tetraethylene glycol dimethyl ether (tetraglyme), triethyl phosphate (TEP), and combinations thereof. The plasticizing solution can comprise one or more lithium salts including LiBF₄, LiClO₄, LiPF₆, LiAsF₆, LiTf, LiFSI, LiTFSI, LIBOB, and combinations thereof.

In one embodiment, the plasticizer solution comprises 17.5 wt. % to 27.5 wt. % LiTFSI and 72.5 wt. % to 82.5 wt. % triethylene glycol dimethyl ether, 20.5 wt. % to 24.5 wt. % LiTFSI and 75.5 wt. % to 79.5 wt. % triethylene glycol dimethyl ether, or about 22.5 wt. % LiTFSI and about 77.5 wt. % triethylene glycol dimethyl ether.

In one embodiment, the plasticizer solution comprises 56 wt. % to 66 wt. % LiTFSI and 33.5 wt. % to 43.5 wt. % triethylene glycol dimethyl ether, 59 wt. % to 63 wt. % LiTFSI and 36.5 wt. % to 40.5 wt. % triethylene glycol dimethyl ether, or about 61.25 wt. % LiTFSI and about 38.75 wt. % triethylene glycol dimethyl ether.

In one embodiment, the plasticizer solution comprises 16 wt. % to 26 wt. % LiTFSI, 9 wt. % to 19 wt. % triethylene glycol dimethyl ether, and 55 wt. % to 75 wt. % triethyl phosphate. In another such embodiment the plasticizer solution comprises 19 wt. % to 23 wt. % LiTFSI, 12 wt. % to 16 wt. % triethylene glycol dimethyl ether, and 60 wt. % to 70 wt. % triethyl phosphate. In another such embodiment the plasticizer solution comprises about 21.25 wt. % LiTFSI, 13.75 wt. % triethylene glycol dimethyl ether, and about 65 wt. % triethyl phosphate.

In some embodiments, the various plasticizer solutions described above can be utilized to produce a solid gel electrolyte film which is assembled into a battery cell 10 with an anode 11 comprising LTO, graphite, or silicon and/or SiOₓ host material 13, and a cathode 14 comprising LMO, lithium iron phosphate, lithium manganese iron phosphate, NMC, NCMA, or HE-NMC active materials 16. In a particular embodiment, battery cell 10 comprises LTO host material 13 and LMO active material 16. In all such embodiments, the solid gel electrolyte film (i.e., separator 18) can have a thickness of 20 μm to 100 μm, 30 μm to 90 μm, or 40 μm to 80 μm.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method for forming a battery cell, the method comprising:
providing a porous polymeric membrane;
imbibing the porous polymeric membrane with a plasticizing solution comprising one or more plasticizers and one or more lithium salts to form a solid gel electrolyte film; and
disposing the solid gel electrolyte film between an anode and a cathode.

2. The method of claim 1, wherein the porous polymeric membrane is provided as a coating on the anode.

3. The method of claim 1, wherein the porous polymeric membrane is provided as a coating the cathode.

4. The method of claim 1, wherein the porous polymeric membrane comprises polyvinylidene fluoride-co-hexafluoropropylene.

5. The method of claim 1, wherein the porous polymeric membrane has a porosity of 20 vol. % to 90 vol. %.

6. The method of claim 1, wherein the porous polymeric membrane further comprises filler particles selected from the list consisting of metal oxides and solid electrolyte powders.

7. The method of claim 6, wherein the filler particles have an average particle size of 10 nm to 3 μm.

8. The method of claim 6, wherein the porous polymeric membrane comprises 10 wt. % to 60 wt. % filler particles.

9. The method of claim 1, wherein the one or more plasticizers comprise triethylene glycol dimethyl ether, tetraethylene glycol dimethyl ether, triethyl phosphate, and combinations thereof.

10. The method of claim 1, wherein the one or more lithium salts comprise LiBF₄, LiClO₄, LiPF₆, LiAsF₆, LiTf, LiFSI, LiTFSI, LIBOB, and combinations thereof.

11. The method of claim 17, wherein the plasticizer solution comprises 17.5 wt. % to 27.5 wt. % LiTFSI and 72.5 wt. % to 82.5 wt. % triethylene glycol dimethyl ether.

12. The method of claim 17, wherein the plasticizer solution comprises 56 wt. % to 66 wt. % LiTFSI and 33.5 wt. % to 43.5 wt. % triethylene glycol dimethyl ether.

13. The method of claim 17, wherein the plasticizer solution comprises 16 wt. % to 26 wt. % LiTFSI, 9 wt. % to 19 wt. % triethylene glycol dimethyl ether, and 55 wt. % to 75 wt. % triethyl phosphate.

14. The method of claim 1, wherein the solid gel electrolyte film has a thickness of 20 μm to 100 μm.

15. The method of claim 1, wherein the porous polymeric membrane comprises a solid body populated with a plurality of pores, and imbibing includes impregnating the plurality of pores and the solid body with the one or more lithium salts.

16. The method of claim 1, wherein the anode comprises LTO, graphite, or silicon particles and/or SiOₓ particles, and the cathode comprises LMO, lithium iron phosphate, lithium manganese iron phosphate, NMC, NCMA, or HE-NMC.

17. A method for forming a solid gel electrolyte membrane for a battery cell, the method comprising:
providing a porous polymeric membrane comprising polyvinylidene fluoride-co-hexafluoropropylene; and
imbibing the porous polymeric membrane with a plasticizing solution to form a solid gel electrolyte film, wherein the plasticizing solution comprises LiTFSI and one or more plasticizers selected from the list consisting of triethylene glycol dimethyl ether, tetraethylene glycol dimethyl ether, and Triethyl Phosphate.

18. The method of claim 17, wherein the plasticizer solution comprises 17.5 wt. % to 27.5 wt. % LiTFSI and 72.5 wt. % to 82.5 wt. % triethylene glycol dimethyl ether.

19. The method of claim 17, wherein the plasticizer solution comprises 56 wt. % to 66 wt. % LiTFSI and 33.5 wt. % to 43.5 wt. % triethylene glycol dimethyl ether.

20. The method of claim 17, wherein the plasticizer solution comprises 16 wt. % to 26 wt. % LiTFSI, 9 wt. % to 19 wt. % triethylene glycol dimethyl ether, and 55 wt. % to 75 wt. % triethyl phosphate.
